(19) United States
(12) Patent Application Publication
(10) Pub. No.: US 2006/0257003 A1
(43) Pub. Date: Nov. 16, 2006

(54) Method for the automatic identification of entities in a digital image

(76) Inventor: Sanite V. Adelbert, Vincennes (FR)

Correspondence Address: PATENT LEGAL STAFF, EASTMAN KODAK COMPANY, 343 STATE STREET, ROCHESTER, NY, 14650-2201, US

(21) Appl. No.: 10/548,943

(22) PCT Filed: Mar. 1, 2004
(86) PCT No.: PCT/EP04/02017

§ 371 Date: Jun. 2, 2006

(30) Foreign Application Priority Data
Mar. 14, 2003 (FR) 0303143

(51) Int. Cl. G06K 9/00

(52) U.S. Cl. 382/103; 382/190

(57) ABSTRACT

The present invention is in the technical field of imaging. The present invention relates to a method implemented by using a terminal (1), (2) provided with a display screen (11), (14). This method enables, in a displayed digital image (22) belonging to a set of digital images including identification information stored in a statistical database (16), automatic identification of the homogenous pixel entities (35), (36) and (37). The invention method is used advantageously to interpret, classify and retrieve, rapidly and reliably, images linked for example to a particular event.

The present invention is in the technical field of imaging. The present invention relates to a method for the identification or marking of images, implemented by using a terminal provided with a display screen. This method enables, in a displayed digital image, an automatic identification of entities of mutually homogeneous pixels.

In terminal digital networks, the display and communication of still or moving digital images, with which for example additional text information is associated, are obtained using means that seek to be user friendly and interactive. User friendliness and interactivity are obtained by reducing, on the terminals, the number of manual operations of processing or managing said digital images. Methods and systems, which implement communication means enabling multimedia messages comprising digital images to be formed, processed, transmitted or received, exist in the prior art. The digital images of these multimedia messages comprise for example zones or entities of homogeneous pixels. These homogeneous pixel entities represent, for example, living beings. These living beings can be people. When terminal users exchange digitized photographic images, it is particularly advantageous that these users can enhance these digital images with additional data. These additional data thus enable these images to be identified or marked so as to interpret them, i.e. by recognizing the content more easily. Consequently, these images can be classified more rationally, which also enables them to be retrieved more easily and rapidly. An identification, for example using markings of the last or first names of the people included in the scene of an image, has a very attractive advantage, and enables a user friendly and rapid management of these images from a terminal provided with a display screen.

It is an object of the present invention to facilitate an electronic identification or marking of digital images with data specific to homogeneous pixel entities recorded in the scenes of these images. These homogeneous pixel entities preferably represent living beings. These entities can be identified using an identifier. The identifier of the living being is advantageously a first name. The final objective is to be able to interpret, classify and retrieve, rapidly and reliably, images linked for example to a particular event.

The object of the present invention is a method that enables, from a terminal provided with a display screen, the successive performance of an automatic detection, then recognition of at least a second pixel entity, in a displayed digital image comprising a first already recognized pixel entity. Entity detection is performed in the image by using a specific detection algorithm, generally know to those skilled in the art. Recognition enables an identifier specific to each of the image entities to be displayed in the image. The first entity has a representation of pixels homogeneous with the second entity. It is considered that two or more image entities are “homogeneous”, if they mutually have representational harmony or equivalence, as regards the arrangement and gray levels of the pixels of said entity. This homogeneity is established from parameters specific to the image, such as form, color, luminosity, and contrast. These parameters can be combined with one another: for example form and color (flesh), to detect face type entities in an image. The first entity is generally recognized manually by the terminal user. The recognition of the at least one second entity is automatically performed from statistical data coming from a set of stored digital images. This set of stored digital images includes the displayed digital image and at least one second digital image, different than the displayed digital image. The second digital image includes the first entity and the at least one second entity. The statistical data are stored in a statistical database; these statistical data characterize the appearance occurrences of recognized homogeneous entities, in each image of the set of digital images. The occurrence characterizes the appearance probability of a set of two or more entities in the same stored image.

More specifically, the object of the invention is a method that enables the at least one second entity to be recognized automatically in an image comprising a first and at least one second homogeneous pixel entity, by performing the following steps:

a) automatically detect entities mutually having a representation of homogeneous pixels in the displayed image;

b) assign a first identifier to a first homogeneous entity of the image;

c) automatically display the first identifier in a zone of the displayed image, and correlate said zone to the first entity by a displayed link;

d) automatically store, in the statistical database, the identifier assigned in step b), by association with the first homogeneous entity,

e) automatically assign an identifier to each of the other unidentified entities of the image, according to the statistical data of the database characterizing the appearance occurrences of combinations of identifiers of homogeneous entities in an image, and according to the first identifier assigned in step b);

f) automatically display the identifier assigned to each of the other entities identified in step e), in a zone of the displayed image, by correlating said zone to each of said entities by a displayed link;

g) automatically store in a statistical database a combination of identifiers produced in steps b) and e), for the displayed image.

Step g) of the method enables the statistical database to be enhanced with appearance occurrences of the identifiers of recognized homogeneous entities, as the recognition operations are performed on the digital images including the homogeneous pixel entities. This is to improve automatic recognition.

It is also an object of the invention to automatically produce the identifiers of the homogeneous pixel entities included in an image, in order to reduce the risks of errors due to manual recognition or identification, and while performing these identifications more rapidly and easily.

Other characteristics and advantages will appear on reading the following description, with reference to the drawings of the various figures.

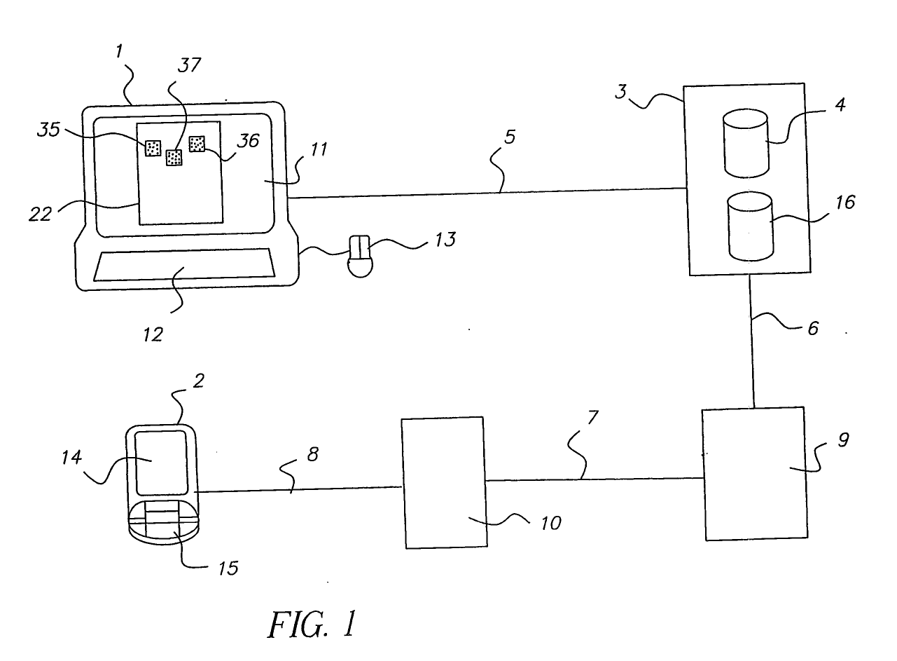

FIG. 1 shows an example of a hardware environment used to implement the invention.

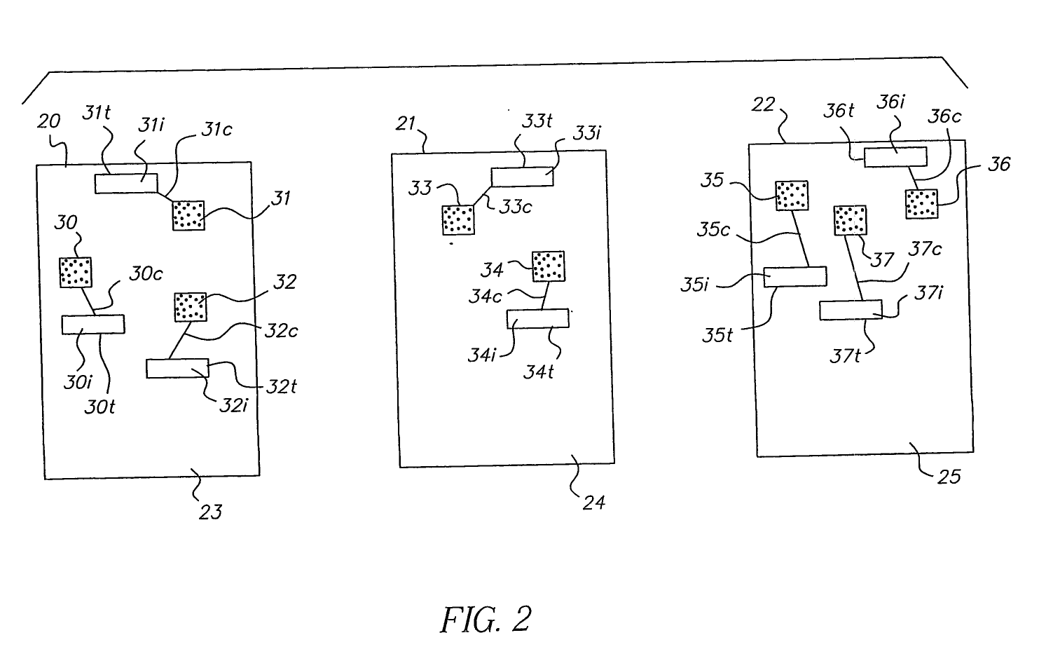

FIG. 2 shows diagrammatically a set of digital images including homogeneous pixel entities, to which the invention method is applied.

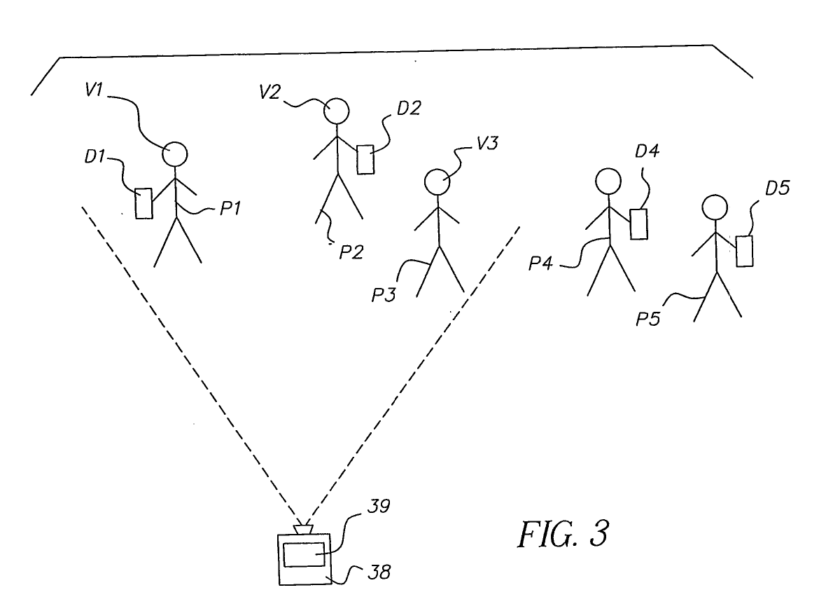

FIG. 3 shows a particular embodiment of implementing the invention method.

The following description is a detailed description of the main embodiments of the method according to the invention; with reference to the drawings in which the same numerical references identify the same elements in each of the different figures.

According to FIG. 1, the present invention relates to a method that enables a user of a terminal 1, 2, to rapidly identify a set of digital images, by personalizing each of these images by markings. These markings are for example identifiers in text form. The invention method enables these markings in text form to be automated, which facilitates identification of the image content, while minimizing manual operations and thus the risk of errors due to these manual operations. Terminal 1 is for example a PC (personal computer) provided with a display screen 11, a keyboard 12, and a mouse 13. The terminal 2 is for example a mobile terminal provided with a display screen 14 and a keyboard 15. The mobile terminal 2 is advantageously a cellphone, a portable phone cam type device or a digital camera provided with a data communication device. The data communication device of the digital camera is for example a wire or wireless modem. The portable phone cam type device or digital camera enables the recording of shots. The recorded images are stored, for example, in a memory of terminal 2; these images have for example a video graphics array (VGA) type resolution of 640 pixels by 480 pixels.

FIG. 1 shows a data server 3 containing digital images, for example arranged or stored on a image database 4 of a memory of the server 3. The server 3 also includes a statistical database 16 that contains information or metadata enabling the identification of the entities of the digital images stored in the image database 4. Advantageously, these digital images include metadata (e.g. author of the image, date and time of recording the image, etc.) associated with the respective image files. The terminal 1 is linked to the data server 3, for example by a cable link 5. The data server 3 is connected by a high-speed link 6 to a host server 9 enabling the connection, by the link 7, to a network like for example the Internet. In the environment of the network shown by FIG. 1, the host server 9 is linked to a gateway 10. The gateway 10 is for example of wireless application protocol (WAP) type, and intended to provide communication, by a link 8, between the mobile terminal 2 and the network. The link 8 is for example a global system for mobile (GSM) type. In a particular embodiment of the invention, the user of the mobile terminal 2 accesses, by using the keyboard 15 of this terminal 2, one or more digital images contained in the database 4, by transmitting a message in the appropriate protocol, for example WAP, intended for a telephone line. The message transits by the gateway 10, where it is transformed into a message according to the hypertext transfer protocol (HTTP), used in the Internet. Thus the user can recover and display on the screen 14 of their terminal, one or more images coming from the database 4.

According to the FIG. 2, it is an object of the present invention to help the user of terminal 1, 2 to mark a set of images 20, 21, 22 each including respectively at least two homogeneous pixel entities 30, 31, 32, 33, 34, 35, 36 and 37. These images are recovered, from terminal 1, 2, in the database 4. The homogeneous entities are zones in the image that have for example homogeneity in the arrangement of pixels and color, this homogeneity being singular in relation to the other pixels 23, 24, 25 forming the rest of the image. The rest of the pixels 23, 24, 25 of the image 20, 21, 22 represent everything not recognized as “homogeneous entity”; the zone of pixels 23, 24, 25 is generally called the “background”. The homogenous entities 30, 31, 32, 33, 34, 35, 36, 37 can be for example living beings or the heads or faces of these living beings. The homogenous entities are, preferably, people's faces.

In an advantageous embodiment of the invention, the user of terminal 1, 2 has a set of images 20, 21, 22 that correspond to a particular event: for example images of a close relative's birthday. This set of images is stored in the image database 4 of a memory of the server 3. The invention method facilitates, effectively and reliably, i.e. rapidly and without error, the automated marking of each image of the set of images 20, 21 and 22. The automatic marking is performed by an algorithm for assigning identifiers, which uses information from the statistical database 16. The marking is effected using identifiers 30i, 31i, 32i, 33i, 34i, 35i, 36i, 37i that characterize the homogenous entities of each image of the set of images. The user, from the terminal 1, 2 can thus view, for example by displaying them successively on the screen 11, 14, a large number of images, for example several tens of images, which form the set of images recorded at the birthday. The invention method enables the automated marking of the homogenous pixel entities of these images.

In a particular embodiment of the invention, the user selects, from the terminal 2, a file of any first image 20 of this set of birthday images 20, 21 and 22. The image 20, displayed on the screen 14, includes for example three homogenous pixel entities 30, 31 and 32. These mutually homogenous entities, which represent for example faces, are automatically detected by the invention method. The face detection operations are performed automatically by a specific detection algorithm. This type of algorithm is known to those skilled in the art. If no data on a previous identification of the homogenous entities of these images is available in the statistical database 16, the user, by using the keyboard 12, 15, manually identifies each face 30, 31, 32 of the first image 20 of the set of images 20, 21 and 22. To perform this identification, the user manually assigns an identifier 30i, 31i, 32i to each homogeneous entity 30, 31, 32 of the image 20. This first manual identification initializes the constitution of the statistical data specific to the occurrences of associations or combinations of the entities in each image of the set of images of the event. To identify each homogeneous entity, the user advantageously uses a screen interface function making appear, on the screen 11, 14, for example a display window (not shown). This display window enables a list of identifiers to be displayed. These identifiers are for example the names or first names automatically proposed by a list. Or, the user manually types these identifiers using the keyboard 12, 15. The identifiers 30i, 31i, 32i thus selected are placed in the zones 30t, 31t, 32t automatically displayed. In a particular embodiment, the user selects, for example by clicking on it, an entity 30; the zone 30t and the link 30c are then placed automatically in relation to said entity 30. Or, in an advantageous embodiment, the blank marking zones 30t, 31t, 32t, and link zones 30c, 31c, 32c are automatically placed in correlation with each homogeneous entity 30, 31 and 32. The text zones 30t, 31t, 32t are correlated with the homogenous entities 30, 31 and 32. The zones 30t, 31t, 32t are linked or attached to the entities 30, 31, 32, for example by displayed links, such as thin linking arrows or lines 30c, 31c and 32c.

In a first embodiment, the automatic display of the zones 30t, 31t, 32t is performed so that all said zones 30t, 31t, 32t are placed, by superimposition, inside the frame of the image 20. In a second embodiment, one part or all the zones 30t, 31t, 32t is placed outside the frame of the image 20, while remaining inside the frame of the display screen 11, 15.

To initialize the method, and feed the statistical database 16 at the start, the user manually assigns all the identifiers 30i, 31i, 32i of the first image 20 to the homogenous entities 30, 31 and 32. The user marks, for example with the first names, the homogeneous entities 30, 31, 32 of the first image 20 of the set of images 20, 21 and 22. These homogeneous entities 30, 31, 32, were first detected automatically in the image 20, by a face detection algorithm. The user assigns successively an identifier 30i, for example “Cyril”, then an identifier 31i, for example “Guillaume”, then an identifier 32i, for example “Sylvain”. For the image 20, these associations or combinations of identifiers are automatically recorded in a specific memory of the statistical database 16.

The user then selects the file of a second image 21 which is displayed on the screen 11, 14. The image 21 includes for example two homogeneous entities 33 and 34 automatically detected in the image 21. The user visually recognizes the homogenous entity 33 as representing for example “Cyril”; this image 21 is the second image of the set of images of the event, for example a birthday. The user assigns (marks) this identifier “Cyril” (33i) specific to the homogeneous entity 33. The invention method automatically recognizes and displays the identifier “Cyril” in a zone 33t of the image 21, by correlating this identifier, by a link 33c, to the homogeneous entity 33. The invention method, from the display of this second image 21, automatically proposes, for the homogeneous entity 34, the identifiers 34i “Guillaume” and “Sylvain”, associations or combinations that were previously stored for the first image 20. The user sees that the homogeneous entity 34 represents “Guillaume”; they click on “Guillaume” in the zone 34t that contains the two automatically proposed identifiers 34i: “Guillaume” and “Sylvain”. The identifier “Guillaume” (34i) is thus assigned to the homogeneous entity 34. For the image 21, the combination of the identifiers 33i (“Cyril”) and 34i (“Guillaume”) is automatically stored in the statistical database 16.

The user then selects the file of a third image 22 which is displayed on the screen 11, 14. The image 22 includes for example three homogeneous entities 35, 36 and 37 automatically detected in the image 22. The user assigns for example “Guillaume” (35i) to the homogeneous entity 35. The invention method automatically recognizes and displays the identifier “Guilaume” in a zone 35t of the image 22, by correlating this identifier 35i, by a link 35c, to the homogeneous entity 35. The invention method proposes for example for the homogeneous entity 36, to automatically assign “Cyril” or “Sylvain” optionally, to this entity. Optionally means that the association data between the previously recorded identifiers involve determining a stronger occurrence of assigning “Cyril” to the homogeneous entity 36 than “Sylvain”. The user effectively recognizes that the homogeneous entity represents “Cyril”; they then validate this assignation by clicking on “Cyril”. The invention method proposes for example for the homogeneous entity 37, to automatically assign “Sylvain” (37i). The user effectively recognizes that the proposed automatic assignation 37i is right. In case of error, the user can manually correct this automatic assignation. The invention method enables the zones 35t, 36t, 37t and the related links 35c, 36c, 37c to be displayed automatically. The association or combination of the identifiers “Guillaume” (35i), “Cyril” (36i), and “Sylvain” (37i), is automatically stored in the statistical database 16. All the associations or combinations of identifiers per image are stored to enhance the statistical database 16 that contains a table of occurrences. This table is managed by an algorithm (spreadsheet program) that automatically determines the greatest probability of finding a combination of identifiers in an image of a set of images, according to the previously stored occurrences of identifier associations. These associations of identifiers and their occurrences form the statistical values of identifier combinations, stored from the images of the set of images. The statistical data are used to automatically assign and automatically display the identifiers to the images displayed on the screen 11, 14.

In a particular embodiment of the invention, the statistical database can be enhanced with temporal and geographic metadata specific to each image. These metadata are for example the geographical location where the image was recorded, the recording date, etc.

In an advantageous embodiment, and according to FIG. 3, the invention method is implemented in a context of capturing images of people. A photographer, equipped with an image capture device 38, records for example an image containing three people P1, P2, P3, included in the scene of the image. Said recorded image does not include P4 and P5. The image capture device 38 has a display screen 39. In the environment out of the scene of the image recorded by the device 38, are also found for example two other people P4 and P5. These two other people P4 and P5 are not placed in the recording field of the device 38. The device is 38 is for example a digital camera capable of communicating with other digital devices D1, D2, D4, D5 (which the people P1, P2, P4, P5 have), by a wire or wireless communication network. This communication network is for example of the type local area network (LAN), personal area network (PAN), or wide area network (WAN). The devices D1, D2, D4, D5 are portable terminals, like for example cellphones, digital cameras, personal digital assistants (PDA). These devices D1, D2, D4, D5 enable data to be stored. The stored data are for example advantageously identification metadata of said devices, the name and first name of the owner of said device, the owner's electronic address (e-mail), etc. According to FIG. 3, the person P1 has for example D1, person P2 has D2, person P4 has D4, person P5 has D5; and person P3 has no device.

The device 38 operates in a hardware environment as illustrated in FIG. 1, and communicates with the statistical database 16. The device 38 also includes software that enables, for example at the moment of recording the image containing P1, P2, P3, according to FIG. 3, the performance of an automatic request to associate the data stored in each device D1, D2, D4, D5 with the identifier data assigned to the homogeneous entities V1, V2, V3. These identifier data assigned to the homogeneous entities V1, V2, V3 are stored in the statistical database 16. By this association, the statistical database 16 is thus enhanced with metadata from the devices D1, D2 and D3. This association leads to the identification of the people P1 and P2 of the recorded image, said people P1 and P2 respectively having devices D1 and D2. In this case, the association of the data is performed automatically by the software of the device 38. Nevertheless, for the person P3 who does not have a device for automatically making the association, the user of device 38 proposes for example an identifier manually, by using the keyboard (not shown) of the device 38. Or, the identifier of P3 is automatically generated by the data of the statistical database 16 alone. The homogeneous entities V1, V2, V3 represent for example the faces of the people P1, P2 and P3. After its recording, the image containing P1, P2, P3 is displayed on the screen 39. The identifiers of the homogeneous entities V1, V2, V3 can thus be assigned by the photographer using the invention method, which automatically recognizes the homogeneous entities of the image recorded by the device 38.

The integration of these metadata in the table of occurrences increases the assignation reliability of identifiers per image, at the time of recognition. Other assumptions can be taken into account by the identifier assignation algorithm: for example for two images having on the one hand close temporal metadata (e.g. the recording instant), and on the other hand having the same number of homogeneous entities (e.g. faces), the assignation algorithm will consider that the probability will be high that the combination of identifiers is the same for these two images. This probability calculation can be weighted by other factors, like for example the author of the recording of the image who cannot be at the same time the photographer and recorded in the image.

While the invention has been described with reference in particular to its preferred embodiments, it is apparent that variants and modifications can be produced within the scope of the claims.

1. A method adapted to automatically detect entities in a displayed digital image having representations of homogenous pixels, and automatically recognize at least one second entity in the displayed digital image including a first recognized entity, the displayed digital image being displayed on a display screen of a terminal, said first entity having a representation of pixels homogeneous with the at least one second entity, the method comprising automatically recognizing the at least one second entity from statistical data from a set of stored digital images including the displayed image, and at least one second image, said at least one second image including the first entity and the at least one second entity, the statistical data being stored in a database, and said statistical data characterizing appearance occurrences of combinations of identifiers of homogeneous entities recognized in each image of the set of stored digital images.

2. The method according to claim 1, wherein the automatic recognition of the at least one second entity of the displayed digital image comprises the steps of:
a) automatically detecting entities mutually having a representation of homogeneous pixels in the displayed image;
b) assigning a first identifier to a first homogeneous entity of the displayed digital image;
c) automatically displaying the first identifier in a zone of the displayed digital image, and correlating said zone to the first entity by a displayed link;
d) automatically storing the identifier (35i) assigned in said step b), by association with the first homogeneous entity;
e) automatically assigning a further identifier to each of the other unidentified entities of the displayed digital image, according to the statistical data of the database characterizing the appearance occurrences of combinations of identifiers of homogeneous entities in an image, and according to the first identifier assigned in said step b);
f) automatically displaying the further identifier assigned to each of the other entities identified in said step e), in a further zone of the displayed image, by correlating said further zone to each of said entities by a displayed link; and
g) automatically storing in the statistical database a combination of the identifiers produced in said steps b) and e), for the displayed digital image.

3. The method according to claim 2, wherein said step a) comprises an automatic detection of form, color, luminosity and contrast.

4. The method according to claim 1, wherein the statistical database is enhanced with temporal and geographic metadata specific to each stored digital image.

5. The method according to claim 1, wherein the statistical database is enhanced with identification metadata automatically communicated between an image capture device and the devices held by people who are present in a scene of an image recorded by said capture device.

6. The method according to claim 2, wherein the zone of the image including the identifier is placed by superimposition in said image.

7. The method according to claim 2, wherein the zone of the image including the identifier is placed outside said image.

8. The method according to claim 1, wherein the homogeneous entities of the digital image are living beings.

9. The method according to claim 1, wherein the homogeneous entities of the digital image are human faces.
